(19) United States
(12) Patent Application Publication
(10) Pub. No.: US 2016/0090792 A1
(43) Pub. Date: Mar. 31, 2016

(54) Auger Blade

(71) Applicant: Bhupinder Grewal, Spartanburg, SC (US)

(72) Inventor: Bhupinder Grewal, Spartanburg, SC (US)

(21) Appl. No.: 14/499,380

(22) Filed: Sep. 29, 2014

(51) Int. Cl. E21B 10/44; A01C 5/02; E21B 11/00

(52) U.S. Cl. CPC E21B 10/44; E21B 11/005; A01C 5/02

(57) ABSTRACT

An auger blade includes a main body which defines a ground penetrating tip portion, a first blade and a second blade. The first and second blades extend from the tip portion towards an opposing end portion of the auger blade. The first and second blades are annularly arranged around a centerline of the auger blade. The first blade includes an arcuate inner surface and the second blade includes an arcuate inner surface.

### FIELD OF THE INVENTION

The present invention generally relates to a landscape auger assembly. More particularly, this invention involves a auger blade for an auger assembly which bores a generally circular hole in soil.

### BACKGROUND OF THE INVENTION

Various tools exist for boring generally cylindrical holes in soil for planting shrubs, trees, plants and/or for digging post holes. One tool particularly suited for such tasks is an auger. Typically, an auger includes a handle or motor connected to one end of a rotatable shaft and a helical blade or bit coupled to an opposing end of the shaft. As the shaft is rotated, the blade digs or cuts into the soil. Soil which is displaced from the ground translates upward along the blade.

Conventionally, the displaced soil is deposited on the ground outside of the hole. One issue with existing augers, particularly auger blades is that at least a portion of the displaced soil may fall back into the hole once the auger blade is removed, thus reducing the depth of the hole and potentially increasing labor time required to complete the planting or post hole digging process. In addition or in the alternative, conventional augers are generally large, heavy and cumbersome to operate, particularly when digging relatively shallow holes (18 inches or less) to receive small plants or shrubs. Therefore, an improved auger blade for boring generally cylindrical holes in soil for planting shrubs, trees or plants would be useful.

### BRIEF DESCRIPTION OF THE INVENTION

Aspects and advantages of the invention are set forth below in the following description, or may be obvious from the description, or may be learned through practice of the invention.

One embodiment of the present invention is an auger blade. The auger blade includes a main body which defines a ground penetrating tip portion, a first blade and a second blade. The first and second blades extend from the tip portion towards an opposing end portion of the auger blade. The first and second blades are annularly arranged around a centerline of the auger blade. The first blade includes an arcuate inner surface and the second blade includes an arcuate inner surface.

Another embodiment of the present invention is a landscape auger. The landscape auger landscape auger comprises a shaft, a handle connected to an end of the shaft and an auger blade connected to an opposite end of the shaft via a connecting member. The auger blade comprises a main body which defines a ground penetrating tip portion, a first blade and a second blade. The first and second blades extend from the connecting member to the tip portion and are annularly arranged and circumferentially spaced apart with respect to a centerline of the shaft. The first blade includes an arcuate inner surface and the second blade includes an arcuate inner surface. The first and second blades converge inwardly from the connecting member towards the tip portion.

Those of ordinary skill in the art will better appreciate the features and aspects of such embodiments, and others, upon review of the specification.

### BRIEF DESCRIPTION OF THE DRAWINGS

A full and enabling disclosure of the present invention, including the best mode thereof to one skilled in the art, is set forth more particularly in the remainder of the specification, including reference to the accompanying figures, in which:

FIG. 1 illustrates an auger assembly according to various embodiments of the present invention;

FIG. 2 is a cross sectional bottom view of an auger blade of the auger assembly as shown in FIG. 1, according to various embodiments of the present invention;

FIG. 3 is a top view of a portion of the auger blade of the auger assembly as shown in FIGS. 1 and 2, according to various embodiments of the present invention;

FIG. 4 is a bottom view of the auger blade as shown in FIG. 1, according to various embodiments of the present invention;

FIG. 5 is a front view of a portion of the auger assembly as shown in FIG. 1, including the auger blade 16 according to one or more embodiments of the present invention;

FIG. 6 is a back view of a portion of the auger assembly as shown in FIG. 1, according to one or more embodiments of the present invention;

FIG. 7 is a left side view of a portion of the auger assembly with a first blade of the auger blade as shown in FIG. 1, according to one or more embodiments of the present invention; and

FIG. 8 is a right side view of a portion of the auger assembly with a second blade of the auger blade as shown in FIG. 1, according to one or more embodiments of the present invention.

### DETAILED DESCRIPTION OF THE INVENTION

Reference will now be made in detail to present embodiments of the invention, one or more examples of which are illustrated in the accompanying drawings. The detailed description uses numerical and letter designations to refer to features in the drawings. Like or similar designations in the drawings and description have been used to refer to like or similar parts of the invention. As used herein, the terms “first”, “second”, and “third” may be used interchangeably to distinguish one component from another and are not intended to signify location or importance of the individual components. The term “radially” refers to the relative direction that is substantially perpendicular to an axial centerline of a particular component, and the term “axially” refers to the relative direction that is substantially parallel and/or coaxially aligned to an axial centerline of a particular component.

Each example is provided by way of explanation of the invention, not limitation of the invention. In fact, it will be apparent to those skilled in the art that modifications and variations can be made in the present invention without departing from the scope or spirit thereof. For instance, features illustrated or described as part of one embodiment may be used on another embodiment to yield a still further embodiment. Thus, it is intended that the present invention covers such modifications and variations as come within the scope of the appended claims and their equivalents.

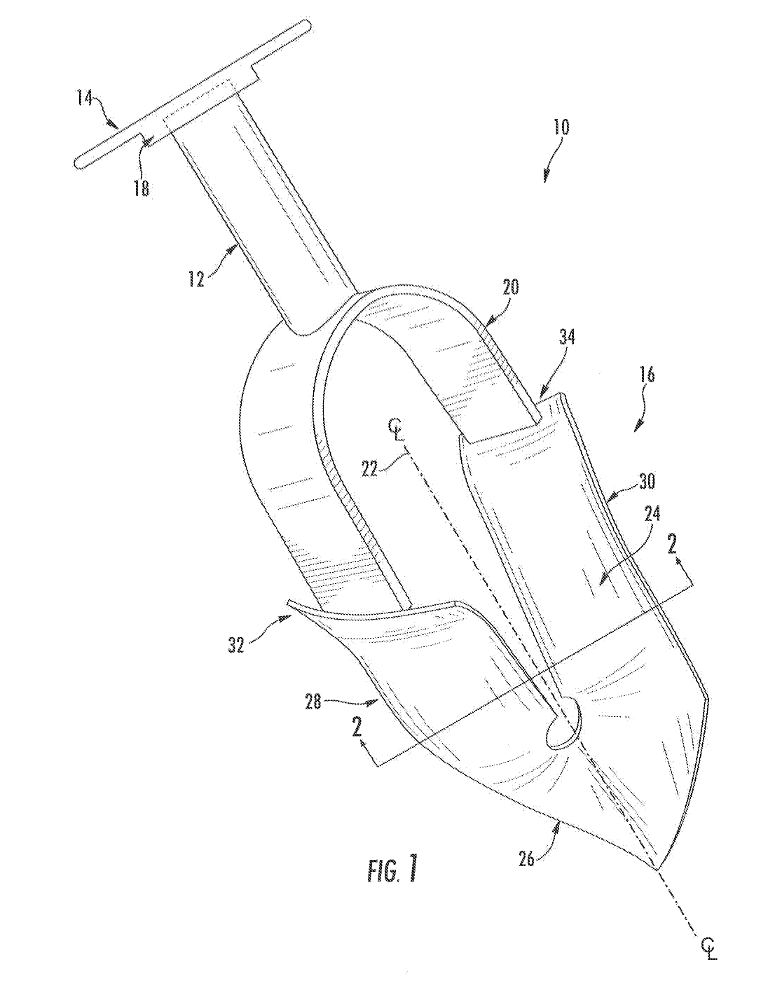

Referring now to the drawings, FIG. 1 illustrates a landscape auger assembly or auger assembly 10 according to various embodiments of the present invention. As shown, the auger assembly 10 includes a shaft 12, a handle 14 disposed at or proximate to one end of the shaft 12 and an auger blade 16 connected or coupled to an opposing end of the shaft 12. The shaft 12 may be made of any material which is suitable for providing torque via the handle 14 to the auger blade 16. For example, the shaft 12 may be made from steel, aluminum, plastic, wood and/or composite materials.

The handle 14 may be any shape suitable for applying torque to the shaft 12. For example, the handle 14 may be T-shaped or have a hub and spoke shape. The handle 14 may include a ratchet 18 or other device which allows the operator to rotate the shaft 12 one or more rotations without having to change their footing position.

The auger blade 16 may be coupled or connected to the shaft 12 via a connecting member 20. The connecting member 20 may have any form and may connect to the shaft 12 directly or via an additional connecting member (not shown).

For example, the connecting member 20 may be press fit to the shaft 12, bolted, screwed or welded to the shaft 12. In alternate embodiments, the shaft 12 and the connecting member 20 may be formed (e.g. cast, molded or machined) together as a singular component. In one embodiment, as shown in FIG. 1, the connecting member 20 forms a U-shape. In other embodiments, the connecting member 20 may include multiple U-shaped members. In other embodiments, the connecting member 20 may be at least partially arcuate or circular. For example, the connecting member 20 may have a hub and spoke shape which is substantially coaxially aligned with a centerline 22 of the auger blade 16. The connecting member 20 is generally formed to allow for connection of the auger blade 16 to the shaft 12.

In various embodiments, as shown in FIG. 1, the auger blade 16 includes a main body 24. The main body 24 defines a ground penetrating tip portion 26, a first blade 28 and a second blade 30. The first and second blades 28, 30 extend from the tip portion 26 towards corresponding opposing end portions 32, 34 of the first and second blades 28, 30. In particular embodiments, the first and second blades 28, 30 are fixedly connected to the connecting member 20 at and/or proximate to the corresponding end portions 32, 34. Either or both of the first and second blades 28, 30 may be bolted, welded or otherwise fixedly connected to the connecting member 20. In alternate embodiments, the main body 24 and the connecting member 20 may be formed as singular component.

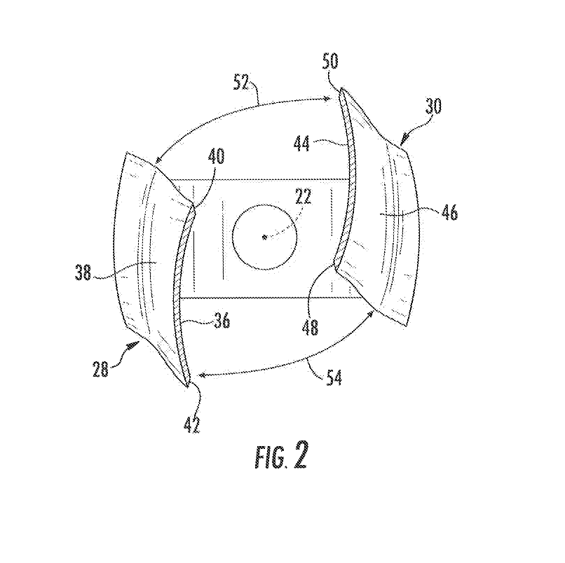

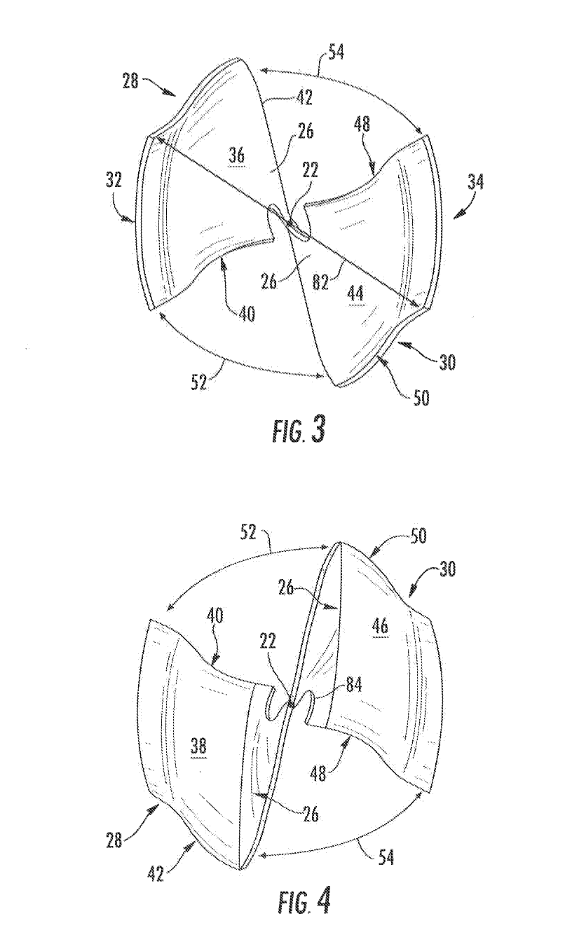

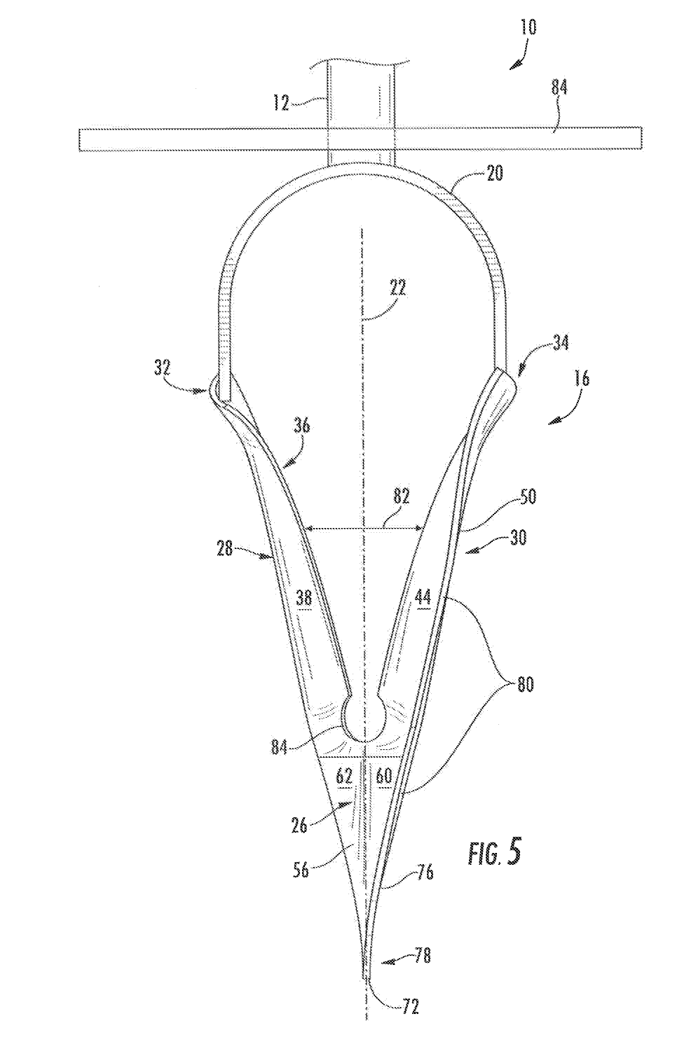

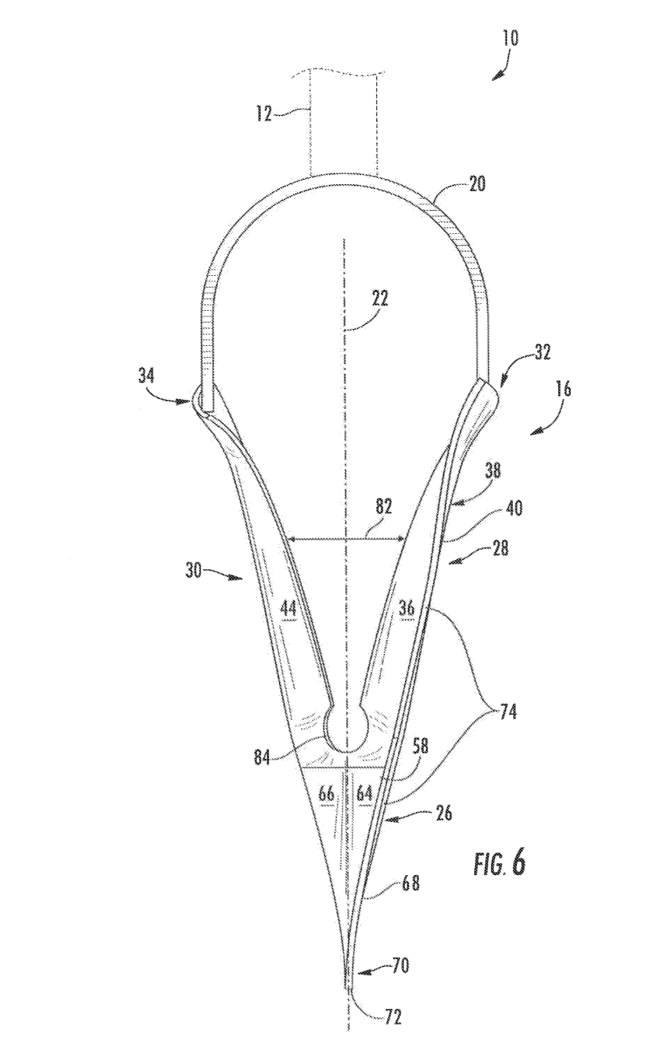

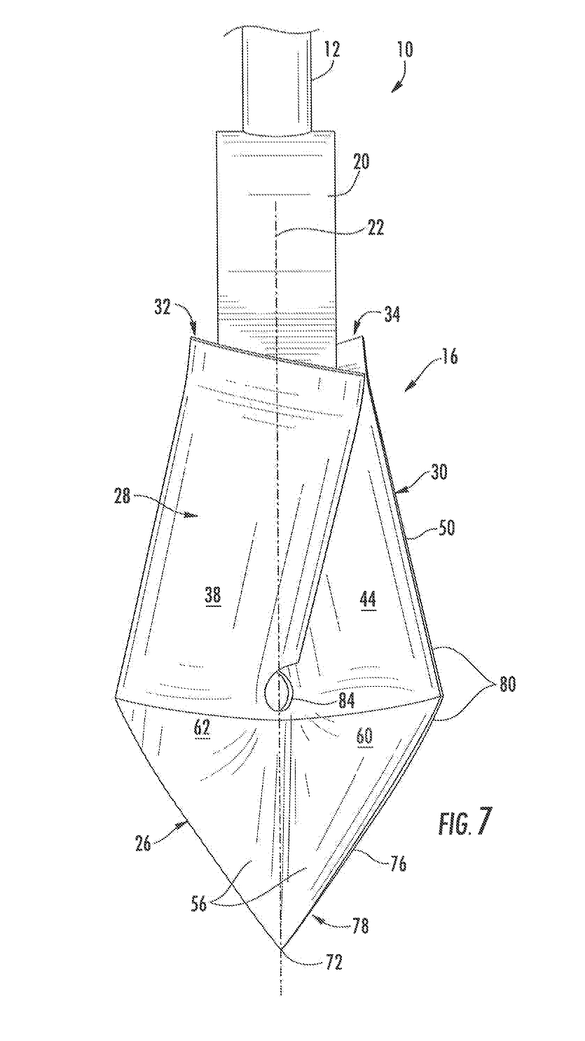

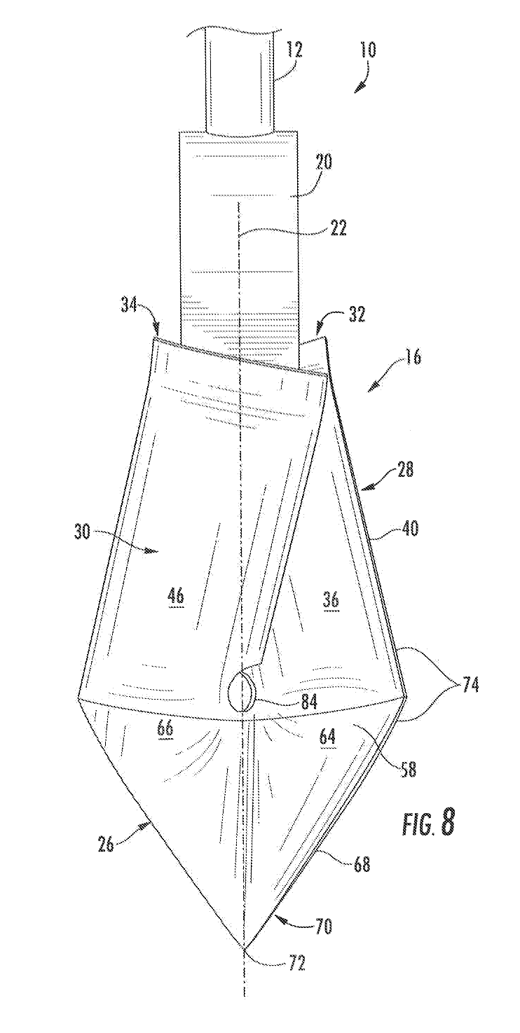

FIG. 2 provides a cross sectional bottom view of the auger blade assembly 10 as shown in FIG. 1, with the tip portion 26 of the auger blade 16 cut away for clarity according to various embodiments of the present invention. FIG. 3 is a top view of a portion of the auger blade 16 as shown in FIGS. 1 and 2, according to various embodiments of the present invention. FIG. 4 is a bottom view of the auger blade 16 according to various embodiments of the present invention. FIG. 5 provides a front view of a portion of the auger assembly 10 including the auger blade 16, the connecting member 20 and a portion of the handle 12 as shown in FIG. 1. FIG. 6 provides a back view of a portion of the auger assembly 10 including the auger blade 16, the connecting member 20 and a portion of the handle 12 as shown in FIG. 1. FIG. 7 provides a left side view of a portion of the auger assembly 10 with the first blade 28 in the foreground. FIG. 8 provides a right side view of a portion of the auger assembly 10 with the second blade 30 in the foreground.

As shown in FIGS. 1-8, the first and second blades 28, 30 are annularly arranged around the centerline 22 of the auger blade 16. As shown, the first blade 28 is circumferentially spaced apart from the second blade 30 with respect to centerline 22. In one embodiment, as illustrated in FIGS. 1-6, the first blade 28 is diametrically opposite to the second blade 30 with respect to centerline 22.

In various embodiments, as shown in FIGS. 2 and 3 the first blade 28 includes an arcuate inner surface 36. In particular embodiments, as shown in FIGS. 2, and 4 the first blade 28 includes an arcuate outer surface 38 which is defined radially outwardly from the arcuate inner surface 36. As shown in FIG. 6, the arcuate inner surface 36 generally extends at least partially between the tip portion 26 and the opposing end portion 32 of the first blade 28. As shown in FIGS. 5 and 7, the arcuate outer surface 38 generally extends at least partially between the tip portion 26 and the opposing end portion 32 of the first blade 28.

In particular embodiments, as shown in FIGS. 2 and 3, the arcuate inner surface 36 extends circumferentially between a primary leading or cutting edge portion 40 of the first blade 28 and a primary trailing edge portion 42 of the first blade 28. In particular embodiments, as shown in FIGS. 2 and 4, the arcuate outer surface 38 extends circumferentially between the primary leading or cutting edge portion 40 and the primary trailing edge portion 42 of the first blade 28. The primary cutting edge portion 40 may be shaped or formed so as to define a sharp edge for cutting through soil as the auger assembly 10 is rotated into the ground. In particular embodiments, as shown in FIG. 2, at least a portion of the arcuate inner surface 36 may be concave and at least a portion of the arcuate outer surface 38 may be convex with respect to center line 22.

In various embodiments, as shown in FIGS. 2 and 3 the second blade 30 includes an arcuate inner surface 44. In particular embodiments, as shown in FIGS. 2, and 4 the second blade 30 includes an arcuate outer surface 46 which is defined radially outwardly from the arcuate inner surface 44. As shown in FIG. 5, the arcuate inner surface 44 generally extends at least partially between the tip portion 26 and the opposing end portion 32 of the second blade 30. As shown in FIGS. 6 and 8, the arcuate outer surface 46 generally extends at least partially between the tip portion 26 and the opposing end portion 34 of the second blade 30.

In particular embodiments, as shown in FIGS. 2 and 3, the arcuate inner surface 44 extends circumferentially between a secondary leading or cutting edge portion 48 of the second blade 30 and a secondary trailing edge portion 50 of the second blade 30. In particular embodiments, as shown in FIGS. 2 and 4, the arcuate outer surface 46 extends circumferentially between the secondary leading or cutting edge portion 48 and the secondary trailing edge portion 50 of the second blade 30. The secondary cutting edge portion 48 may be shaped or formed so as to define a sharp edge for cutting through soil as the auger assembly 10 is rotated into the ground. In particular embodiments, as shown in FIG. 2, at least a portion of the arcuate inner surface 44 may be concave and at least a portion of the arcuate outer surface 46 may be convex with respect to center line 22.

As shown in FIGS. 2-4, the primary leading or cutting edge portion 40 of the first blade 28 is spaced circumferentially from the secondary trailing edge portion 50 of the second blade 30 and the secondary leading or cutting edge portion 48 of the second blade 30 is spaced circumferentially from the primary trailing edge portion 42 of the first blade 28. As a result, corresponding circumferential gaps or openings 52 and 54 are defined between the primary leading or cutting edge portion 40 of the first blade 28 and the secondary trailing edge portion 50 of the second blade 30 and the secondary leading or cutting edge portion 48 of the second blade 30 and the primary trailing edge portion 42 of the first blade 28.

In various embodiments, as shown in FIGS. 5 and 7, the tip portion 26 of the auger blade 16 includes an arcuate first side surface 56 and as shown in FIGS. 6 and 8, the tip portion 26 includes an arcuate second side surface 58. In certain embodiments, as illustrated in FIG. 7, the arcuate first side surface 56 includes a concave portion 60 and a convex portion 62. In particular embodiments, the arcuate first side surface 56 transitions between the concave portion 60 and the convex portion 62 at, along or approximate to the centerline 22.

In various embodiments, as shown in FIGS. 5 and 7, the concave portion 60 of the arcuate first side surface 56 of the tip portion 26 may be continuous with the arcuate inner surface 44 of the second blade 30. As further shown in FIGS. 5 and 7, the convex portion 62 of the arcuate first side surface 56 may be continuous with the arcuate outer surface 38 of the first blade 28. In particular embodiments either or both of the concave or convex portions 60, 62 of the arcuate first side surface may blend into the corresponding arcuate inner surface 44 of the second blade 30 the arcuate outer surface 38 of the first blade 28.

Similarly, as shown in FIGS. 6 and 8, the arcuate second side surface 58 includes a concave portion 64 and a convex portion 66. In particular embodiments, the arcuate second side surface 58 transitions between the concave portion 64 and the convex portion 66 at, along or approximate to the centerline 22.

In various embodiments, as shown in FIGS. 6 and 8, the concave portion 64 of the arcuate second side surface 58 of the tip portion 26 may be continuous with the arcuate inner surface 36 of the first blade 28. As further shown in FIGS. 6 and 8, the convex portion 66 of the arcuate second side surface 58 may be continuous with the arcuate outer surface 44 of the second blade 30. In particular embodiments either or both of the concave or convex portions 64, 66 of the arcuate second side surface may blend into the corresponding arcuate inner surface 36 of the first blade 28 or the arcuate outer surface 44 of the second blade 30.

As further shown in FIGS. 6 and 8, the tip portion 26 is formed to define a cutting edge 68 along the first arcuate side surface 56. The cutting edge 68 extends from a point 70 which is at or proximate to a terminating point 72 of the tip portion 26. In particular embodiments, the cutting edge 68 extends from point 70 to the primary cutting edge 40 of the first blade 28. In certain embodiments, the cutting edge 68 is continuous with the primary cutting edge 40 of the first blade 28. In other words, the cutting edge 68 and the primary cutting edge 40 form a continuous cutting surface 74 (FIG. 8) of the auger blade 16 which extends from point 70 towards and/or to end portion 32.

As further shown in FIGS. 5 and 7, the tip portion 26 is formed to define a cutting edge 76 along the second arcuate side surface 58. The cutting edge 76 extends from a point 78 which is at or proximate to the terminating point 72 of the tip portion 26. In particular embodiments, the cutting edge 76 extends from point 78 to the secondary cutting edge 50 of the second blade 30. In certain embodiments, the cutting edge 76 is continuous with the secondary cutting edge 50 of the second blade 30. In other words, the cutting edge 76 and the secondary cutting edge 50 form a continuous cutting edge 80 of the auger blade 16 which extends from point 78 towards and/or to end portion 34.

In various embodiments, as shown in various figures such as FIGS. 1, 5 and 6, the first and second blades 28, 30 converge radially inwardly from the connecting member 20 and/or the end portions 32, 34 towards the tip portion 26 with respect to centerline 22. In addition, as illustrated each of the first and second blades 28, 30 are twisted or swept angularly with respect to centerline 22. As shown in FIGS. 1, 3, 5 and 6, the converging and twisting nature of the first and second blades 28, 30 forms a converging pocket or void 82 between the inner arcuate surfaces 36, 40. In some embodiments, the auger blade may include a cut, slot, groove or other stress relief feature 84 disposed at or proximate to an intersection where the first and second blades 28, 30 intersect with the tip portion 26.

In operation, a worker places the terminating point 72 of the tip portion 26 into the ground or soil. This may be accomplished by applying a downward force at the handle 14, allowing auger to drop tip portion first onto the ground and/or by placing a foot on the connecting member 20 or on a step bar 86 (FIG. 5) and pushing downward towards the ground. Torque may then be applied to the handle 14. The cutting edges 68, 76 of the tip portion 26 cut into the soil thus displacing soil. The displaced soil is guided across the concave portions 64, 60 of the first and second arcuate sides 56, 58 of the tip portion 26 as the auger blade 16 travels downward into the soil. The primary cutting edge 40 of the first blade 28 and the secondary cutting edge 50 of the second blade 30 engage with the soil further displacing additional soil such that the displaced soil transitions along the inner arcuate surfaces of the first and second blades 28, 30 within the pocket 82. Once the auger blade has reached a maximum or desired depth, the auger assembly 10 may be lifted generally vertically from the soil.

Depending on the composition and consistency of the soil, the displaced soil or at least a portion of the displaced soil may stay within the pocket 82. The worker may then place a plant or shrub into the hole. The worker may use at least a portion of the displaced soil from the pocket 82 to plant the plant or shrub. In addition or in the alternative, the displaced soil or any leftover portion of the displaced soil may be relocated or placed into a rubbish container or bin.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other and examples are intended to be within the scope of the claims if they include structural elements that do not differ from the literal language of the claims, or if they include equivalent structural elements with insubstantial differences from the literal language of the claims.

What is claimed is:

1. A auger blade, comprising:
a main body defining a ground penetrating tip portion, a first blade and a second blade, the first and second blades extending from the tip portion towards an opposing end portion of the auger blade, the first and second blades being annularly arranged around a centerline of the auger blade;
wherein the first blade includes an arcuate inner surface and the second blade includes an arcuate inner surface.

2. The auger blade as in claim 1, wherein the arcuate inner surfaces of both the first and second blades are substantially concave.

3. The auger blade as in claim 1, wherein the first blade includes an arcuate outer surface and the second blade includes an arcuate outer surface.

4. The auger blade as in claim 3, wherein the arcuate outer surfaces of the first and second blades are substantially convex.

5. The auger blade as in claim 1, wherein the tip portion includes an arcuate first side surface and an arcuate second side surface, wherein the arcuate first side surface includes a concave portion and a convex portion.

6. The auger blade as in claim 5, wherein the concave portion of the arcuate first side surface of the tip portion is continuous with the arcuate inner surface of the second blade.

7. The auger blade as in claim 5, wherein the convex portion of the arcuate first side surface of the tip portion is continuous with the arcuate outer surface of the first blade.

8. The auger blade as in claim 1, further comprising a connecting member for connecting the auger blade to a shaft, wherein the first blade and the second blade are connected to the connecting member at correspond end portions of the first and second blades.

9. The auger blade as in claim 8, wherein the first and second blades converge inwardly from the corresponding end portions towards the tip portion.

10. The auger blade as in claim 1, wherein the first blade defines a primary cutting edge and a primary trailing edge.

11. The auger blade as in claim 10, wherein the tip portion includes a cutting edge which extends from a terminating point of the tip portion towards the first blade, wherein the tip portion cutting edge is continuous with the primary cutting edge.

12. The auger blade as in claim 1, wherein the second blade defines a secondary cutting edge and a secondary trailing edge.

13. The auger blade as in claim 12, wherein the tip portion includes a cutting edge which extends from a terminating point of the tip portion towards the second blade, wherein the tip portion cutting edge is continuous with the secondary cutting edge.

14. A landscape auger, comprising;
a shaft;
a handle connected to an end of the shaft;
an auger blade connected to an opposite end of the shaft via a connecting member, the auger blade comprising:
a main body defining a ground penetrating tip portion, a first blade and a second blade, the first and second blades extending from the connecting member to the tip portion, the first and second blades being annularly arranged and circumferentially spaced apart with respect to a centerline of the shaft;
wherein the first blade includes an arcuate inner surface and the second blade includes an arcuate inner surface;
wherein the first and second blades converge inwardly from the connecting member towards the tip portion.

15. The landscape auger as in claim 14, wherein the arcuate inner surfaces of both the first and second blades are substantially concave.

16. The landscape auger as in claim 14, wherein the first blade includes an arcuate outer surface and the second blade includes an arcuate outer surface, wherein the arcuate outer surfaces of the first and second blades are substantially convex.

17. The landscape auger as in claim 14, wherein the tip portion includes an arcuate first side surface and an arcuate second side surface, wherein the arcuate first side surface includes a concave portion and a convex portion and wherein the concave portion of the arcuate first side surface of the tip portion is continuous with the arcuate inner surface of the second blade and wherein the convex portion of the arcuate first side surface of the tip portion is continuous with the arcuate outer surface of the first blade.

18. The landscape auger as in claim 14, wherein the first blade defines a primary cutting edge and a primary trailing edge and the tip portion defines a cutting edge which extends from a point at or proximate to a terminating point of the tip portion towards the first blade, wherein the tip portion cutting edge is continuous with the primary cutting edge.

19. The landscape auger as in claim 14, wherein the second blade defines a secondary cutting edge and a secondary trailing edge and the tip portion includes a cutting edge which extends from a point at or proximate to a terminating point of the tip portion towards the second blade, wherein the tip portion cutting edge is continuous with the secondary cutting edge.

20. The landscape auger as in claim 14, wherein the connecting member is u-shaped or cylindrical.
